(19) United States
(12) Patent Application Publication
(10) Pub. No.: US 2024/0349827 A1
(43) Pub. Date: Oct. 24, 2024

(54) FACE MASK, SEAL AND MASK BODY

(71) Applicant: Ernest Wai Yin Lau, Belfast, County Antrim (GB)

(72) Inventor: Ernest Wai Yin LAU, Belfast, County Antrim (GB)

(21) Appl. No.: 18/684,473

(22) PCT Filed: Aug. 19, 2022
(86) PCT No.: PCT/EP2022/073259

§ 371 Date: Feb. 16, 2024

(30) Foreign Application Priority Data
Aug. 19, 2021 (GB) 2111890.6

(51) Int. Cl. A41D 13/11; A62B 23/02

(52) U.S. Cl. CPC A41D 13/11; A62B 23/025

(57) ABSTRACT

The seal is an elastic seal 100 that forms a sealing perimeter around the nose and mouth of a wearer. The elastic seal 100 comprises a first end 104 defining a first opening, a second end 108 defining a second opening in communication with the first opening, and a sidewall 112 extending between the first end 104 and the second end 108. The mask body 200 comprises a porous material. The mask body 200 is supported on the elastic seal 100 such that it covers the second opening of the elastic seal 100. The elastic seal 100 may comprise regions 114 distributed around a perimeter of the sidewall 112 and having a greater rigidity than a remainder of the elastic seal 100. The mask body may comprise a top panel 202 with one or more pleats 222.

The present disclosure is directed towards a face mask, seal and mask body. Face masks are and may be used in several applications including personal protective equipment (PPE), continuous positive airways pressure (CPAP) ventilation and mechanical ventilation of the lungs using a minimally invasive oropharyngeal or nasopharyngeal airway.

### BACKGROUND

Face mask seals are desired to form an air-tight seal around the nose and mouth of the wearer so as to effectively control the ventilation of human or animal wearer of the face mask.

Face mask bodies are desired to perform a filtering function and may also include a valve. The combination of a filter and valve can provide two-way protection for both the wearer and the surrounding environment against microbial and particulate contamination.

Existing face mask seals follow two main designs. A first type of face mask seal forms a parallel seal with stretching securement. This type of face mask seal is commonly seen in surgical face masks. The parallel seal relies on the mask margin overlapping with the wearer's skin for a variable width to form the seal. A mask using the parallel seal is typically made of one or more flat panels of flexible fabrics cut into specific shapes and joined along certain edges to create a three-dimensional form that accommodates the nose protuberance and follows the sagittal curvature of the human face to the chin. A piece of malleable (usually made of metal) strip may be embedded in the upper rim of the mask for crimping around the nose bridge so that the mask margin “hugs” the two shorter edges of the nose-cheek triangles. The parallel seal is typically secured to the wearer's face by stretching its margin backwards with straps. This is referred to as “stretching securement”.

The parallel seal mask is based on approximation of three-dimensional geometry with flat panels. Even though the malleable nose crimp helps the mask hug the nose-cheek triangles and the flexible panels improve the mask's ability to conform to the human facial contour, the fit is unlikely to be perfect and the parallel seal can leak significantly. However, the parallel seal exerts relatively little pressure on the wearer's face and is made of softer materials. As a result, the parallel seal mask can be worn for a long time without causing skin damage.

A second type of face mask seal forms a perpendicular seal with compressive securement. This type of face mask seal is commonly seen in N95 respirators. The “perpendicular” seal is typically made of a semi-rigid plastic material formed into a specific three-dimensional shape to match the human facial contour. The nose-cheek triangles are typically filled by triangular-shaped flanges in the seal. To improve the fit and wearer's comfort, the seal margin may be lined with compressible padding materials that deform under pressure to plug the gap between the semi-rigid mask margin and the human facial contour. The perpendicular seal is typically compressed against the wearer's face from the front by pulling its base backwards with straps. This is referred to as “compressive securement”.

The perpendicular seal may need to exert considerable pressure on the wearer's skin to prevent air leakage. The softer deformable padding material may not disperse the elevated pressure over an area much wider than the harder semi-rigid seal margin, resulting in indentations and even pressure ulcers on the wearer's face. Because the mask is semi-rigid and inelastic, it is less able to deform to conform to changes in the shape of the wearer's face.

Even though the parallel seal and perpendicular seal masks can deform to accommodate variation in the shape of the human wearer's face to an extent, their constituent materials are inelastic and cannot significantly change in dimensions. When the wearer opens his or her mouth (e.g., in order to speak), the mask may not lengthen vertically enough so that the chin slips out of the seal. The mask will also become narrower horizontally, pulling the seal margin forwards and away from contact with the cheeks, creating lateral gaps around the seal. The soft tissues of the cheeks move towards the midline as they are stretched, further widening the lateral gaps around the seal.

The human face is highly variable in shape. Multiple face mask models may need to be produced, which greatly increases the manufacturing complexity and costs. Fit testing also needs to be conducted to match each wearer with a suitable mask model. Fit testing requires special equipment and trained personnel to conduct and is time consuming (up to 30 minutes for each test subject). When a large workforce needs to be fit tested, the exercise can be extremely disruptive and very costly in terms of trained fit testing personnel, specialist equipment and lost productivity.

Existing face mask filters are typically made of one or more layers of porous materials such as non-woven fabrics, melt blown fabrics; but also woven fabrics like cotton and other material. The filter may form the entirety or majority of the mask body or may be confined to a rimmed area of the mask body.

Some of the filters can be replaced with disposable inserts. The fabrics forming the bulk of the mask and the filter holder may be washed and reused. Some of the filters are semi-rigid and could be moulded into specific shapes to form the mask. Other filters are flexible.

A problem with replaceable filters is that they require a further seal in addition to the mask seal that forms the sealing perimeter around the nose and mouth of the wearer. The further seal is required to form the seal between the filter and the mask body. This increases the complexity and cost of achieving air tightness.

Most filters are formed from fibres with gaps that are able to block the passage of fine particles but unable to block the microbial or particulate agents. To block a high percentage of particles, the filter needs to be thicker, increasing the airflow resistance and making it harder for the wearer to breathe. With use, more particles are trapped between the filter fibres and the airflow resistance rises, making it harder for the wearer to breathe. The particles trapped between the filter fibres cannot be efficiently removed. The filter thus has a limited working life span and must be replaced to reduce airflow resistance.

Flexible fabric mask bodies can collapse and wrap around the nose and mouth of the wearer during deep inspiration. This can reduce the efficiency of inhalation as some of the energy is used to deform the mask body rather than move air, increases the airflow resistance as only the small areas of filter directly over the wearer's nostrils and the mouth may be available for air movement, increases contact between the inside of the mask and the wearer's face and risk of contamination by water droplets or other materials deposited on the inside of the mask, and causes discomfort to the wearer.

Moisture can condense on and within the filter from the water vapour exhaled by the wearer. The water droplets provide a moist environment for bacteria and fungi to grow. The wearer's mouth and tongue can become contaminated if they touch the inside of the mask by accident or if the mask/filter collapses under negative pressure. Flexible fabric mask bodies collapsing during inhalation can be mitigated by putting a semi-rigid frame to prop up the mask body, adding to the bulk, weight and rigidity of the mask.

Face mask valves open during exhalation and close during inhalation. Such valves may be referred to as exhalation valves. Existing face mask valves are contained within a flat rigid cage embedded in the mask. The side of the cage has slits to allow air movement. The bottom of the cage is embedded in the mask and has an orifice spanned by struts. The orifice is covered by a semi-rigid flap either adherent to one side of the cage bottom or mounted on a short stem inserted through the centre of the struts. The struts stop the flap from falling through the orifice into the interior of the mask. When the external (outside the mask) pressure is equal to or above the internal (within the mask) pressure, the flap covers the orifice in the cage and the valve is shut for airflow. When the internal pressure rises above the external pressure (such as when the wearer exhales), the flap lifts off from the orifice and air flows outwards from within the mask through the slits in the cage. These exhalation valves are typically mounted on the front or sides of the face mask.

A problem with existing exhalation valves is that the exhaled air is not filtered. While this may lower the airflow resistance the wearer has to overcome during exhalation, the unfiltered exhaled air exposes the people and the environment to potential contamination originating from the wearer.

It is an object of the present disclosure to provide an improved face mask construction.

It is an object of the present disclosure to provide an improved seal such as for use as a face mask seal.

It is an object of the present disclosure to provide an improved mask body construction for a face mask.

### SUMMARY

There is provided a face mask, elastic seal and mask body as set out in the accompanying claims. Other features of the invention will be apparent from the dependent claims, and the description which follows.

According to a first aspect of the disclosure, there is provided a face mask comprising an elastic seal and a mask body. The elastic seal is arranged to form a sealing perimeter around the nose and mouth of a wearer. Additionally, the elastic seal my from a sealing perimeter around the mouth and eyes and nose of a wearer. The elastic seal comprises a first end defining a first opening, a second end defining a second opening in communication with the first opening and a sidewall extending between the first end and the second end. The mask body comprises a porous material. The mask body is supported on the elastic seal such that it covers the second opening of the elastic seal.

Advantageously, the face mask comprises an elastic seal. The elastic seal is formed from an elastic material such as natural or synthetic rubber and is able to be stretched and then return to its original size and shape when the stretching force is removed. The elastic seal may be referred to as an elastic band, elastic loop, or elastic tube.

In use, the first end of the elastic seal is stretched to accommodate the wearer. The elastic seal attempts to return to its original size and shape. This results in the elastic seal urging against the wearer to form a sealing perimeter around the nose and mouth of the wearer. The elastic seal is able to form an effective sealing perimeter for a variety of facial shapes and is able to maintain the sealing perimeter as the wearer opens their mouth.

The mask body covers the second opening of the elastic seal. When the face mask is worn, an internal volume is defined between the mask body and the wearer. Air may be inhaled and exhaled by the wearer through the porous material of mask body.

The mask body is formed from a porous material that is suitable to act as a filter. A separate filter is not required as the mask body itself forms the filter. The filter is arranged to trap elements such as microbes and particulates such as dusts and pollens while allowing air exchange with the external environment. Any porous material such as a porous fabric can be used to make the mask body. For some advantageous arrangements, the mask body comprises polytetrafluoroethylene (PTFE) and in particular expanded or sintered PTFE or a structurally reinforced composite material based on porous PTFE. Using PTFE or a composite therefore allows the mask body to be cleaned at a molecular level through capillary action with perfluorocarbons. This allows the mask body to be reconditioned and reused. In one example, the mask body is formed from a porous PTFE material that is sandwiched between two protective mesh layers.

The porous materials may be impregnated with a means for adsorbing chemicals and/or biological agents. Alternatively, at least one face mask insert may be impregnated with a means for adsorbing chemicals and/or biological agents.

The porous materials may be impregnated with materials such as activated charcoal or copper for adsorption of noxious chemicals and/or for killing of microbes. Alternatively, the at least one insert disposed in the face mask may be impregnated with materials such as activated charcoal or copper for adsorption of noxious chemicals and/or for killing of microbes. The face mask may be a gas mask for industrial use and/or for use against chemical weapons and/or for use against biological agents. In this embodiment the face mask covers the entire face of the wearer thereby covering the wearer's eyes. In this embodiment the seal covers the entire face of the wearer thereby covering the wearer's eyes. Means are provided for allowing a wearer to see through a face mask of the type which covers the entire face of the wearer. Transparent portions are provided in a corresponding location of the mask to the eyes of a wearer for allowing a wearer to see through a face mask of the type which covers the entire face of the wearer.

The elastic seal may comprise a plurality of regions distributed around a perimeter of the sidewall. The plurality of regions having a greater rigidity than a remainder of the elastic seal.

Advantageously, the elastic seal may comprise a plurality of regions distributed around the perimeter of the sidewall. The plurality of regions are more rigid than the remainder of the elastic seal. When the elastic seal is stretched to accommodate the object, the less rigid sidewall stretches in preference to the plurality of regions. The sidewall lengthens in the direction of stretching and contracts in the direction transverse to the direction of stretching. By contrast, the plurality of regions are substantially unchanged and do not lengthen or contract. In this way, the plurality of regions help resist the first end and the second end from contracting towards one another as the elastic seal is stretched. This helps preserve the available surface area for forming the seal.

The regions may be formed from an elastic material that is able to stretch and return to its original size and shape but are more rigid than the remainder of the elastic seal such that they are more resistant to stretching and require a greater force to be applied in order to deform.

The regions extend in the width direction of the elastic seal which is defined as the direction extending from the first end to the second end. At least one of the plurality of regions may extend along the sidewall from the first end to the second end. The at least one of the plurality of regions may therefore extend along the full width of the sidewall. All of the regions may extend along the sidewall from the first end to the second end. The regions are not required to extend along the full width of the sidewall and may extend along part of the width. The regions may extend from the first end and may terminate before the second end. The regions may extend from the second end and may terminate before the second end. The regions may extend towards the first end and the second end but may terminate before both the first end and the second end.

The first end may be smaller than the second end when the elastic seal is unstretched. The elastic seal may form a substantially frustoconical shape when unstretched.

The plurality of regions may converge towards the first end and spread apart towards the second end.

The rigidity of at least one of the regions may vary such that the at least one of the plurality of regions is more rigid towards the second end and less rigid towards the first end. This is particularly advantageous when the first end is smaller than the second end. When the first end is stretched, the region will attempt to spring back to its original, unstretched, orientation. This helps maintain an effective seal against the object even when the object changes dimensions.

The regions may be formed from the same material as the sidewall. The regions may be integrally formed with the sidewall. The elastic seal including the regions may be formed by integrally moulding an elastic material such as a synthetic or natural rubber.

The regions may project outwardly from an outer surface of the sidewall to form a plurality of ridges. The regions may be formed from the same material as the sidewall but may have a greater rigidity as a result of being thicker than the sidewall.

The regions may comprise more material towards the second end and less material towards the first end. The regions may be thicker towards the second end and thinner towards the second end.

The regions may be formed from a different material to the sidewall. The regions may be attached to the sidewall. The regions may comprise a material having shape-memory and/or super-elasticity such as nitinol.

The face mask may further comprise a harness arranged to support the elastic seal on the object. The harness may be coupled to the second end of the elastic seal.

The elastic seal may comprise at least one recess sized to accommodate part of the mask body. The at least one recess may be formed in a surface of the second end that faces away from the first end.

The mask body may comprise a flexible and non-extendable porous material that is folded to form a three-dimensional shell comprising a top panel, and a plurality of side panels extending from the top panel. The mask body may be formed from any flexible and non-extendable porous material such as PTFE or a composite thereof as described above.

Advantageously, the mask body may be formed from a single folded sheet of flexible and non-extendable porous material without any joints formed by welding, sewing, adhesives, or other attachment methods. A single sheet of material may be folded to form the mask body. This simplifies the construction of the mask body as separate elements are not required to be attached together to form the mask body. The absence of joints that require attachment reduces the risk of leakage and simplifies the manufacturing process.

The top panel may comprise at least one pleat. The pleat may be formed by folding the material of the mask body.

Advantageously, the at least one pleat increases the surface area of the mask body available for filtration without increasing the mask volume. This means that the mask body provides a lower airflow resistance. Breathing is easier for the wearer as there is lower airflow resistance and hence lower inspiratory pressure is required. Moreover, the breathing is more energy efficient as there is less dead space to ventilate for the wearer.

Advantageously still, the at least one pleat provides additional rigidity to the mask body which means that the mask body is less likely to collapse and wrap around the wearer's nose and mouth during inhalation. The pleat provides additional rigidity without increasing the bulk and weight of the mask body. A separate rigid frame is not required to provide structure to the mask body.

Advantageously still, the at least one pleat enables the mask body to increase in size when the wearer opens their mouth. This helps prevent the mask body from slipping off the wearer's face.

Advantageously still, the at least one pleat can function as a bellow when actuated by the jaw muscles of the wearer to refresh the air in the mask, aid the wearer's breathing, or force out water vapour that may otherwise condense into droplets within the mask. This bellow function can be intentionally activated by the wearer or may occur coincidentally such as when the wearer speaks.

The at least one pleat may comprise a plurality of pleats. The plurality of pleats may be arranged parallel to one another along the top panel.

Two of the side panels arranged opposite one another and separated by the top panel may comprise a corresponding at least one pleat. When the top panel comprises a plurality of pleats, the two of the side panels may each comprise a corresponding plurality of pleats. The pleats of the side panels may be aligned with the pleats of the top panel.

The at least one pleat may be formed by folding the mask body along fold-lines. The fold-lines may be stiffened regions of the mask body.

The mask body may further comprise a valve provided between a pair of adjacent side panels. The mask body may comprise a plurality of valves each provided between a pair of adjacent side panels. The valve may be formed by folding the mask body. The mask body may be folded along fold-lines. The fold-lines may be stiffened regions of the mask body.

The valve may be normally closed and may open in response to air pressure increasing within the mask body. When the valve opens, it may define an air passageway for air to escape from the mask body. The air passageway may face away from the top panel and may be provided towards a lower margin of the side panels.

Advantageously, when the pressure increases within the mask body, such as due to the wearer exhaling, the valve opens. The air passageway formed by the valve faces away from the top panel which means that the exhaled air first hits the top panel before bouncing off into the valve for expulsion via the air passageway. Water and mucus droplets and other large particles expelled by the wearer are likely to be deposited on the top panel and only air and gases are expelled to the outside through the valve.

The valve may project outwardly from the pair of adjacent side panels.

The valve may be formed by folding the material along three fold-lines to form a pair of facing sides that terminate in an outer-edge. The sides may move away from each other in response to the pressure within the mask body increasing. The sides may taper towards an upper margin of the side panels. The sides may comprise cut-out regions towards a lower margin of the side panels. The cut-out regions define an air passageway which opens in response to pressure within the mask body increasing.

According to a second aspect of the disclosure, there is provided an elastic seal arranged to form a seal around an object. The elastic seal comprises a first end defining a first opening. The elastic seal comprises a second end defining a second opening in communication with the first opening. The elastic seal comprises a sidewall extending between the first end and the second end. The elastic seal comprises a plurality of regions distributed around a perimeter of the sidewall, the plurality of regions having a greater rigidity than a remainder of the elastic seal.

The elastic seal is not limited to forming seals around any particular object. However, in preferred examples, the elastic seal is used as a face mask seal to form a sealing perimeter around the nose and mouth of a wearer. The elastic seal may therefore be used to improve the sealing of face masks. The elastic seal may be provided as part of a face mask. The seal is not limited to use in face mask seals and can also be used to form seals around other objects such as other parts of animal (such as a human) anatomy. In some examples, the seal can be used to form a sealing perimeter around the eyes of the wearer to protect the eyes from contact with water or other toxic or undesirable substances.

Advantageously, the elastic seal comprises a plurality of regions distributed around the perimeter of the sidewall. The plurality of regions are more rigid than the remainder of the elastic seal. When the elastic seal is stretched to accommodate the object, the less rigid sidewall stretches in preference to the plurality of regions. The sidewall lengthens in the direction of stretching and contracts in the direction transverse to the direction of stretching. By contrast, the plurality of regions are substantially unchanged and do not lengthen or contract. In this way, the plurality of regions help resist the first end and the second end from contracting towards one another as the elastic seal is stretched. This helps preserve the available surface area for forming the seal.

The elastic seal may comprise any of the features of the elastic seal described above in relation to the first aspect of the disclosure.

The elastic seal may be arranged to form a seal around a wearer. The elastic seal may be a face mask seal arranged to form a sealing perimeter around a nose and mouth of the wearer.

Advantageously, the present disclosure provides an elastic face mask seal that is able to be stretched to accommodate various facial sizes and shapes. A single size of elastic seal may be utilised for multiple different facial sizes and shapes. It is therefore not required for the wearer to go through fit testing to find the correct face mask seal size. The plurality of regions having a greater rigidity than the remainder of the elastic seal help prevent the face mask seal from contracting as the wearer opens their mouth which stops the face mask seal from sliding forwards and forming gaps between the cheeks of the wearer and the face mask seal.

According to a third aspect of the disclosure, there is provided a sealing assembly comprising: an elastic seal according to the second aspect of the disclosure and a harness arranged to support the seal on the object. The harness may be coupled to the second end of the elastic seal.

According to a fourth aspect of the disclosure, there is provided a mask body comprising a flexible and non-extendable porous material folded to form a three-dimensional shell comprising a top panel, and a plurality of side panels extending from the top panel, wherein the top panel comprises at least one pleat.

The mask body may comprise any of the features of the mask body described above in relation to the first aspect of the disclosure.

According to a fifth aspect of the disclosure, there is provided a mask body comprising a flexible and non-extendable porous material folded to form a three-dimensional shell comprising a top panel, aa plurality of side panels extending from the top panel, and a valve provided between a pair of adjacent side panels. The valve is arranged to open in response to the pressure within the mask body increasing.

The mask body may comprise any of the features of the mask body described above in relation to the first aspect of the disclosure.

According to a sixth aspect of the disclosure, there is provided a method of forming a mask body, the method comprising: providing a sheet of flexible and non-extendable porous material; folding the sheet of material to form a three-dimensional shell comprising a top panel, and a plurality of side panels extending from the top panel.

The folding may further comprise folding the top panel to form at least one pleat.

The folding may further comprise folding the sheet to form a vale between a pair of adjacent side panels.

### BRIEF DESCRIPTION OF THE DRAWINGS

Examples of the present disclosure will now be described with reference to the accompanying drawings, in which:

FIG. 1 shows an elastic seal according to aspects of the present disclosure applied around an object;

FIGS. 2A to 2D show a variety of facial structures accommodating an elastic seal according to aspects of the present disclosure;

FIG. 3A shows an elastic seal according to aspects of the present disclosure applied around an object with a convex cross-section;

FIG. 3B shows an elastic seal according to aspects of the present disclosure applied around an object with a non-convex cross-section;

FIG. 4 shows an elastic seal according to aspects of the present disclosure applied around an object and secured on the object using a harness;

FIGS. 5A and 5B show an elastic seal according to aspects of the present disclosure in an unstretched and stretched configuration;

FIGS. 6A to 6D show an elastic seal according to aspects of the present disclosure;

FIGS. 7A to 7C show the elastic seal of FIGS. 6A to 6D applied around an object with a non-convex cross-section;

FIGS. 8A and 8B show the elastic seal of FIGS. 6A to 6D applied around a conical shaped object;

FIGS. 9A to 9D show the elastic seal of FIGS. 6A to 6D applied to the face of a wearer so as to function as a face mask seal;

FIG. 10 shows an example sheet of porous material which may be folded to form a mask body according to aspects of the present disclosure;

FIGS. 11A and 11B show an example mask body formed from the sheet of porous material of FIG. 10;

FIGS. 12A and 12B show an example elastic seal according to aspects of the present disclosure arranged to support the mask body of FIGS. 11A and 11B;

FIGS. 13A and 13B show a face mask comprising the mask body of FIGS. 11A and 11B and the elastic seal of FIGS. 12A and 12B; and

FIGS. 14A and 14B show the face mask of FIGS. 13A and 13B applied to the face of a wearer.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise.

The present disclosure relates to a face mask, elastic seal and mask body. The elastic seal can be included as part of the face mask but this is not required in all examples. The elastic seal may be provided in isolation and may be used for forming seals around other objects. The elastic seal is not limited to use as a face mask seal for forming a sealing perimeter around the nose and mouth of the wearer although this is an advantageous implementation. The mask body may be provided in isolation. The mask body may be used with the elastic seal to form the face mask but this is not required in all examples. The mask body may be used with other forms of face mask seals.

To aid in the understanding of elastic seals, an explanation of the forces applied when an elastic seal is applied around different shapes is provided.

When an elastic seal is applied around a tubular object it forms a parallel seal due to the overlap in area between the elastic seal and the object as well as a perpendicular seal. The perpendicular seal is caused due to the normal force pressing the elastic seal against the sealed object generated by the tangential tension within the elastic seal. An elastic seal is inherently capable of changing its dimensions.

An elastic seal forms a tight seal around a tubular object such as a cylinder. It will be appreciated that, the more the elastic seal is stretched around a tubular object, the tighter the resultant seal.

When an elastic seal is applied around a cylinder, for a tangential tension T, the normal force N exerted on a short circular arc of radius of curvature ρ and length δs is given by:

$$N = 2 T \cdot δϕ = 2 T \cdot \frac{δ s / 2}{ρ} = \frac{T}{ρ} δ s ⇒ \frac{N}{δ s} = \hat{n} = \frac{T}{ρ} \qquad ( 1 )$$

where \hat{n}=N/δs is the normal force per unit length of the arc.

An example elastic seal may have a length of 2πR in its neutral relaxed (unstretched) state and an elasticity constant k, ρ=R+δR, then:

$$T = k ( 2 π \cdot δ R ) = 2 π k \cdot δ R \qquad ( 2 )$$

Substituting equation (2) into equation (3):

$$\hat{n} = \frac{T}{ρ} = k \frac{2 π \cdot δ R}{R + δ R} = 2 π k \frac{δ R / R}{1 + δ R / R} \qquad ( 3 )$$

The larger the strain δR/R on the elastic seal (i.e. the more the seal is stretched or the larger the radius of curvature the object it is put around), the higher the normal force per unit length \hat{n} pressing the elastic seal against the object. Therefore, the more an elastic seal is stretched around a tubular object, the tighter the seal between the two.

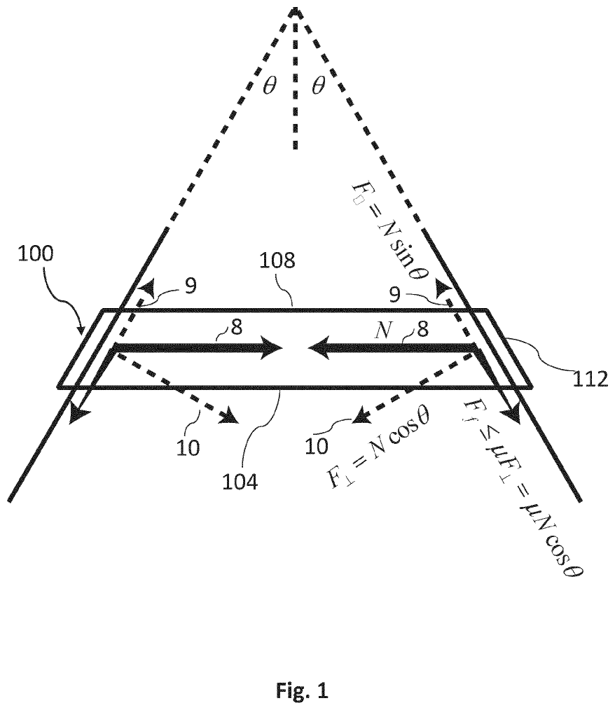

FIG. 1 shows an elastic seal 100 applied around an object with a sloped surface. The object is a circular cone. The elastic seal 100 comprises a first end 104 defining a first opening (not shown) and a second end 108 defining a second opening (not shown) in communication with the first opening. A sidewall 112 extends between the first end 104 and the second end 108. In this example, the first and second openings are circular when the elastic seal is unstretched and have the same diameter.

The elastic seal 100 has been stretched to accommodate the object. The elastic seal 100 is therefore under tension, and exerts a centripetal (i.e. directed towards and perpendicular to the longitudinal axis of a cone) force \hat{n} per unit length on the sloped surface as indicated by the arrows 8 pointing towards the centre of the cone.

A short arc of the elastic seal 100 can be considered as generating a normal force of N on the cone in the direction of the arrows 8.

The tangential force F sliding the elastic seal 100 up the sloped surface (as indicated by the arrows 9) and thus away from the object is given by:

$${F}_{⊓} = N sin θ \qquad ( 4 )$$

Where θ is the slant angle of the object.

The normal force pressing the elastic seal 100 against the sloped surface F_ (as indicated by the arrows 10) is given by:

$$F\_ = N cos θ \qquad ( 5 )$$

The normal force F_{⊥} generates a frictional force F_{f} that acts against other tangential forces to prevent relative movement between the elastic seal 100 and the surface up to a maximum value (the traction):

$${F}_{f} \leq μ {F}_{⊥} = μ N cos θ \qquad ( 6 )$$

where μ is the coefficient of friction between the elastic seal 100 and the sloped surface.

In order for the elastic seal 100 not to slip on the sloped surface:

$${F}_{⊓} = {F}_{j} ⇒ N sin θ \leq μ N cos θ ⇒ tan θ \leq μ \qquad ( 7 )$$

Whether an elastic seal 100 slips on the sloped surface on a circular cone towards the apex depends only on the slant angle θ and the friction of coefficient μ. Slipping is prevented by reducing the slant angle θ or increasing the friction of coefficient μ. An elastic seal may stay stably on the sloped surface of a pointed cone (small slant angle θ) but will tend to roll off the sloped surface of a squat cone (large slant angle θ).

An elastic seal, in isolation, can form an effective seal around objects such as cylindrical or conical objects. However, it can be more challenging to form a seal around a dome-shaped object.

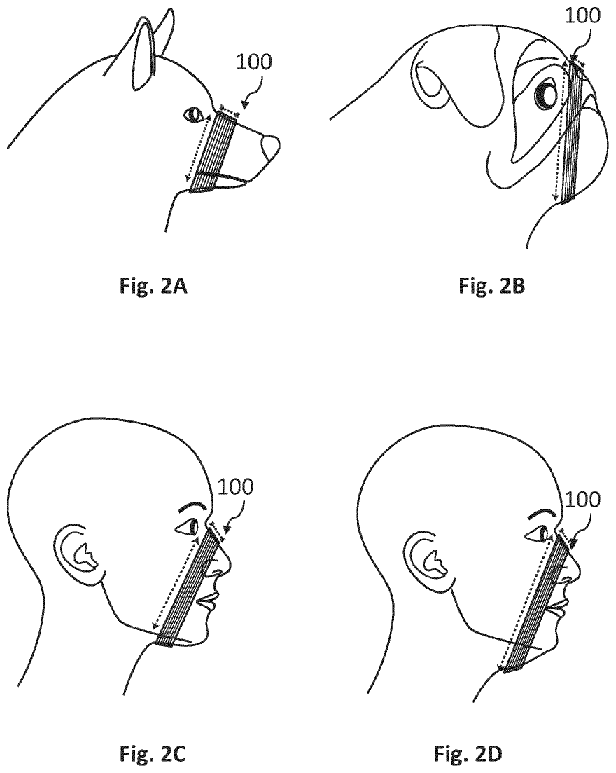

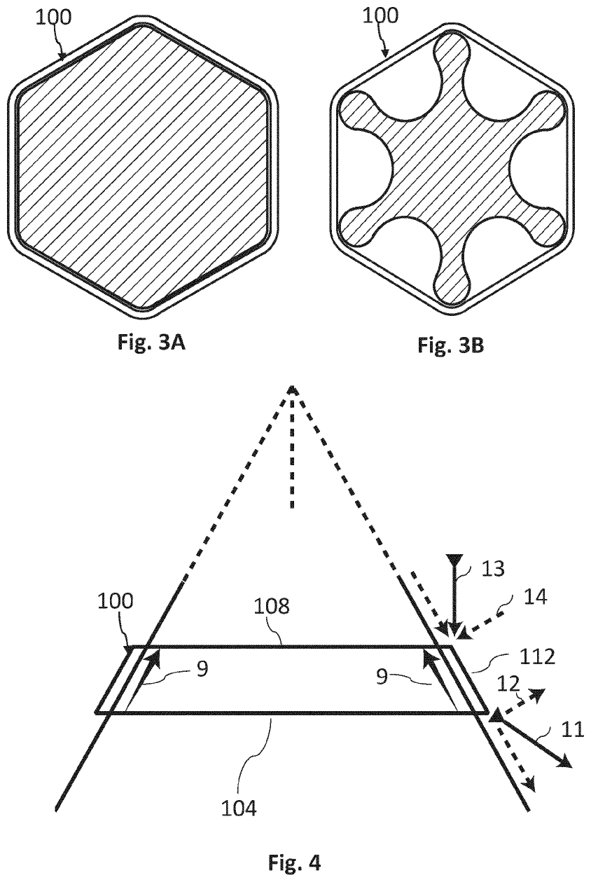

Increasing the tension T in the elastic seal increases the normal force N pressing the elastic seal against the sloped surface and improves the tightness of the seal but may not prevent slippage of the elastic seal. This means that an elastic seal, in isolation, may form an effective seal enclosing the nose and mouth for the wearer for animals with more conical rather than dome-shaped facial profiles. For example, an effective seal can be formed for animals with a long snout (FIG. 2A), but not necessarily for animals with a short snout (FIG. 2B). For humans, the human nose points predominantly downwards and only slightly forwards, resulting in a relatively flat face and not a very favourable geometry for an elastic seal (FIG. 2C), especially in the presence of a heavy jowl (FIG. 2D).

Forming a seal can also be challenging due to the Poisson effect. The Poisson effect refers to how materials deform oppositely in directions perpendicular to that of the primary loading. When an elastic seal is stretched (positive strain in length), it becomes narrower (negative strain in width), and vice versa. As an elastic seal stretches around the sealed object and lengthens, it becomes narrower in its width, resulting in a smaller area of overlap with the sealed object's surface. The reduction in overlap area may undermine the tightness of the seal.

Elastic seals will form an effective seal around objects with convex cross-sections. Here, a convex cross-section will be understood to refer to all of the interior angles being approximately less than 180 degrees. An example elastic seal 100 forming a seal around an object with a convex cross-section is shown in FIG. 3A. However, an elastic seal 100 may not completely seal around an object if its cross-section is non-convex and contains concavities (roughly, some interior angles are >180°), as the elastic seal 100 will tend to be strung taut across the concavities by the adjacent convexities (FIG. 3B). The nose-cheek triangles of the human skull are two such concavities that may prevent an elastic seal from forming an effective seal around the nose and the mouth of a human wearer.

Therefore, while elastic seals 100 can form an effective seal against some objects such as some forms of facial shapes, an elastic seal 100 can struggle to form an effective seal around all objects and particular around human faces which tend to form an approximate dome shape with a non-convex cross-section.

Aspects of the present disclosure are directed towards improved elastic seal constructions to overcome these problems.

The problem of an elastic seal slipping off a domed or other shaped object can be solved by using a harness to support the elastic seal on the object. The harness and elastic seal form a sealing assembly. The sealing assembly may form part of a face mask along with a mask body in some examples.

The harness applies a force to the elastic seal to counter the elastic seal slipping off the sloped surface.

Aspects of the present disclosure relate to providing an elastic seal and a harness arranged to couple the elastic seal to the wearer. The harness applies a force to the elastic seal to prevent the elastic seal from slipping off a sloped surface. The harness may be any means for securing the elastic seal to the object such as straps. For face masks, the harness may be in the form of straps that secure the harness to the back of the head or ears of the wearer.

The harness may secure the elastic seal to the object by stretching the elastic seal backwards in a direction towards the object and thus preventing the elastic seal from slipping off by moving in a direction away from the object. This is referred to as stretching securement. Stretching securement is achieved by the harness pulling the end of the elastic seal facing the object (i.e., the end of the elastic seal that is first inserted over the object).

The harness may secure the elastic seal to the object by compressing the elastic seal against the object. This is referred to as compressive securement. Compressive securement is achieved by the harness pushing against the end of the elastic seal that faces away from the object (i.e., the end of the elastic seal that is opposite to the end that is first inserted over the object).

FIG. 4 shows an elastic seal 100 positioned on a conical object. The elastic seal 100 comprises a first end 104 defining a first opening (not shown), a second end 108 defining a second opening (not shown) and a sidewall 112 extending from the first end 104 to the second end 108. In this example, the first and second openings are circular when the elastic seal is unstretched and have the same diameter.

The elastic seal 100 is stretched over the object. The first end 104 is first received over the object, followed by the sidewall 112 and the second end 108. The first end 104 can be considered as facing towards the object. The second end 108 can be considered as facing away from the object.

In this example, the tangential force (represented by the arrows 9) on the elastic seal 100 exceeds the friction between the elastic seal 100 and the object which means that the elastic seal 100 is under a net dislodging influence. This net dislodging influence tends to cause the elastic seal 100 to slip off the sloped surface.

This net dislodging influence is countered by providing a harness (not shown) which secures the elastic seal 100 to the object and applies a securing force to counter the elastic seal 100 slipping off the object.

The harness may apply the securing force to the first end 104 or the second 108 of the elastic seal 100.

The securing force being applied to the first end 104 is represented by the arrow 11. This is a form of stretching securement as the securing force 11 is applied to the end 104 of the elastic seal 100 that first receives the object and faces towards the object. The securing force 11 tends to stretch the elastic seal 100 which can decrease the force and amount of material pressed against the sloped surface (due to the Poisson effect described above). In particular, the securing force 11 applied to the first end 104 will tend to have a normal component (arrow 12) lifting the elastic seal 100 off the sloped surface.

The securing force being applied to the second end 108 is represented by the arrow 13. This is a form of compressive securement as the securing force 13 is applied to the end 108 of the elastic seal 100 that faces away from the object. The securing force 13 tends to compact the elastic seal 100, increasing the force and amount of material pressed against the sloped surface (due to the Poisson effect described above). In particular, the securing force 13 applied to the second end 108 tends to have a normal component (arrow 14) pressing the elastic seal 100 against the sloped surface. A higher normal force pressing the elastic seal against the sloped surface increases the friction force holding the two items stationary with respect to each other.

Therefore, while a harness applied a securing force to either the first end 104 or the second 108 can stop the elastic seal 100 from slipping off a sloped surface, arranging the harness such that the securing force is applied to the end facing away from the object (the end opposite to the end first applied to the object) is advantageous as it provides compressive securement. A compressive securement has been found to form a more effective seal than a stretching securement when applied to a sloped surface or dome-shaped object.

It will be appreciated that a harness is not required in all examples. Whether or not a harness is required depends on multiple factors such as the shape of the object and the coefficient of friction between the elastic seal and the object. Aspects of the present disclosure relative to advantageous constructions of elastic seals which provide benefits with or without a harness.

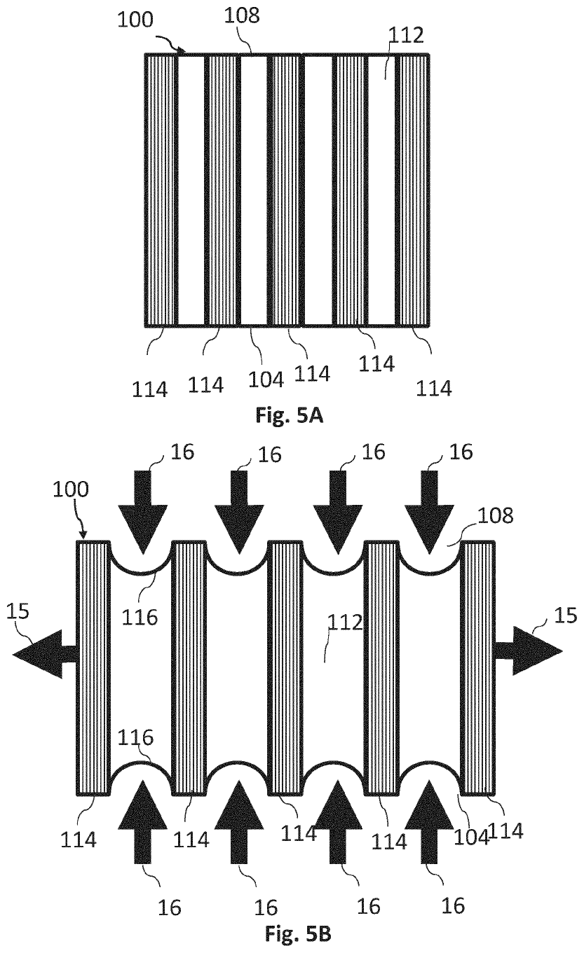

The Poisson effect narrowing the elastic seal 100 as it is stretched can be countered by providing a plurality of regions having a greater rigidity. FIGS. 5A and 5B show an example elastic seal 100 that comprises a first end 104 defining a first opening (not shown), a second end 108 defining a second opening (not shown) in communication with the first opening, and a sidewall extending between the first end 104 and the second end 108. In this example, the first and second openings are circular when the elastic seal is unstretched and have the same diameter.

The elastic seal 100 further comprises a plurality of regions 114 distributed around a perimeter of the sidewall. The plurality of regions 114 have a greater rigidity than a remainder of the elastic seal 100. Five regions 114 are shown in FIGS. 5A and 5B, but it will be appreciated that fewer or more regions 114 may be provided.

The regions 114 are attached to the sidewall 112 and distributed around a perimeter of the sidewall 112. The plurality of regions 114 extend in the width direction between the first end 104 and the second end 108. The regions 114 extend along the full width of the sidewall 112 from the first end 104 to the second end 108. This is not required in all examples, the regions 114 may extend along part of the width of the sidewall 112 between the first end 104 and the second end 108.

The regions 114 may be formed from the same material as the remainder of the elastic seal 100. The regions 114 may therefore be integrally formed with the elastic seal 100. In these examples, the greater rigidity relative to the remainder of the elastic seal 100 is achieved by using more material to form the regions 114 relative to the sidewalls 112. This results in the regions 114 forming ridges that project from the outer surface of the sidewall 112.

It is not required that the regions 114 are formed from the same material as the remainder of the elastic seal 100. The regions 114 could be formed from a different material which has a greater rigidity than the elastic seal 100. The different material is attached to the sidewall 112. The regions 114 of different material may be attached to a base embedded with the outer surface of the sidewall 112. The material could be nitinol for example. When using a different material to the elastic seal 100, the regions may not be required to form thicker segments that extend from the outer surface of the sidewall 112.

The regions 114 are provided to reduce the Poisson deformation of the elastic seal 100 as it is stretched. This means that when the elastic seal 100 is stretched, the regions 114 resist the first end 104 and the second end 108 from contracting towards one another.

FIG. 5A shows the elastic seal 100 when unstretched. FIG. 5B shows the elastic seal 100 when stretched. The stretching force is represented by the arrows 15 and is applied to increase the length of the elastic seal 100 such that the perimeters of the first end 104 and the second end 108 are increased. This in turn increases the size of the first and second openings. The direction in which the stretching force is applied can be referred to as the direction of primary loading. As the regions 114 extend along the width of the sidewall 112 between the first end 104 and the second end 108, they extend in a direction transverse to this direction of primary loading (transverse to the arrows 15 in the Figure).

The stretching of the elastic seal 100 causes the areas of the sidewall 112 provided between the regions 114 to extend in the direction of primary loading in preference to the regions 114. The regions 114 are more rigid than the sidewall 112 and so resist stretching. The stretching of the elastic seal 100 causes Poisson deformation in the transverse direction as indicated by the arrows 16. As the regions 114 deform less in the direction of primary loading, they also display less Poisson deformation in the transverse, width, direction. This reduces the extent the immediately adjacent elastic material of the areas of the sidewall 12 contract transversely. In this way, when the elastic seal 100 is stretched to increase the size of the first and second openings, a series of scallop-shaped recesses 116 are formed, but the overall width of the elastic seal 100 in the transverse direction is preserved. In effect, the regions 114 resist the first end 104 and the second end 108 from contracting towards one another as the elastic seal 100 is stretched.

As the regions 114 resist Poisson deformation as the elastic seal 100 is stretched, they resist the elastic seal 100 from becoming narrower in its width. In this way, the surface area for forming the seal is preserved.

In the example of FIGS. 5A and 5B the first end 104 and the second end 108 have the same size. The elastic seal 100 forms a cylindrical tube shape. The regions 114 are evenly spaced around the perimeter of the sidewall 112 and extend parallel to one another in the width direction between the first end 104 and the second end 108.

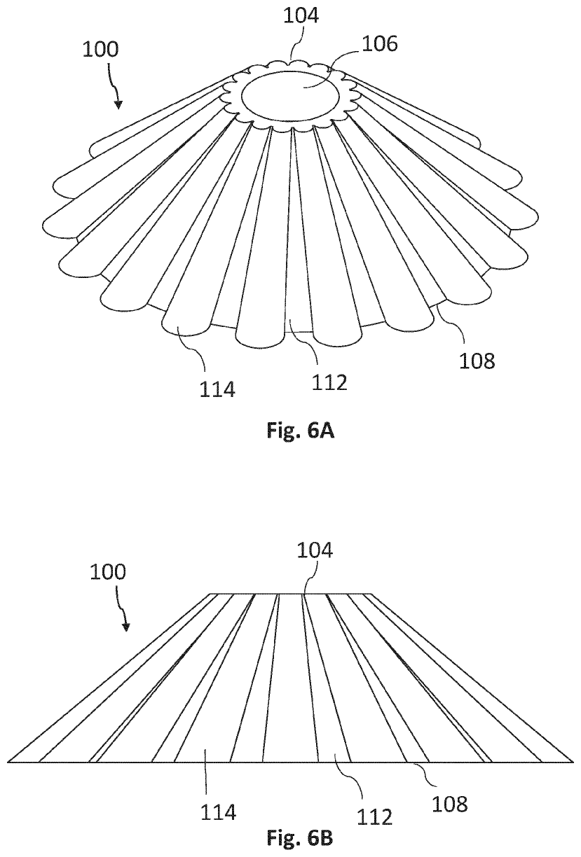

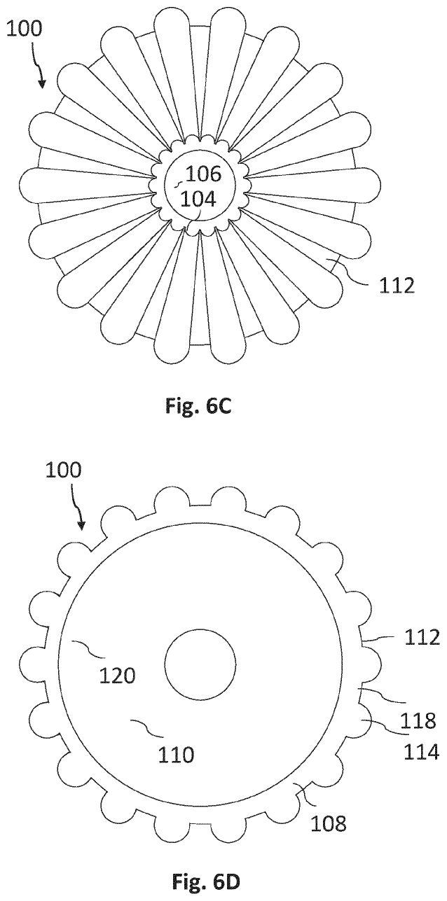

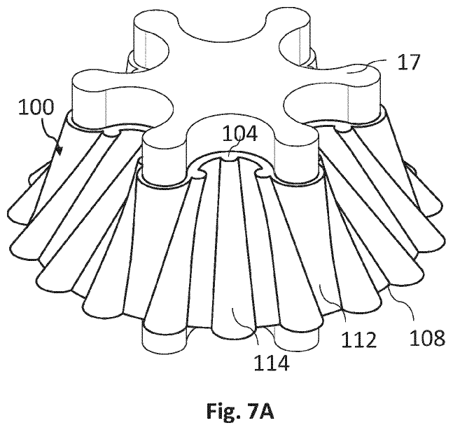

FIGS. 6A to 6D show a further advantageous elastic seal 100 construction that alters the relative size of the first end 104 and the second end 108 such that the first end 104 is smaller than the second end 108. This arrangement increases the sealing effectiveness around objects with non-convex cross-sections such as a human face.

FIGS. 6A to 6D show the elastic seal 100 when unstretched.

Similar to FIGS. 5A to 5B, the elastic seal 100 comprises a first end 104 defining a first opening 106, a second end 108 defining a second opening 110 in communication with the first opening 106, and a sidewall 112 extending between the first end 104 and the second end 108. The elastic seal 100 further comprises a plurality of regions 114 distributed around a perimeter of the sidewall 112. The plurality of regions 114 have a greater rigidity than a remainder of the elastic seal 100. The elastic seal 100 therefore forms a tube with open ends 104, 108.

The first end 104 is smaller than the second end 108. In other words, the first end 104 has a smaller perimeter than the second end 108. The first opening 106 is also smaller than the second opening 110. This arrangement means that the sidewall 112 slopes from the first end 104 to the second end 108. The regions 114 converge towards the first end 104 and spread apart towards the second end 108.

The first end 104 is circular and defines a circular opening 106 in this example. The second end 108 is also circular and defines a circular opening 110. The first end 104 is aligned with the second end 108 in this example. The first opening 106 is aligned with the second opening 110. The first opening 106 and the second opening 110 are concentric. The elastic seal 100 therefore forms a frustoconical shape. This is not required in all examples. The ends/openings could have a different shape such as an elliptical shape.

The regions 114 are formed from the same material as the sidewalls 112. The greater rigidity is achieved by providing the regions 114 as thicker segments of material relative to the sidewalls 112. The thicker segments form ridges that extend from an outer surface 118 (FIG. 6D) of the sidewall 112. The inner surface 120 (FIG. 6D) of the sidewall 112 has a smooth, undisturbed profile. This provides a uniform surface for urging against the object to be sealed.

As explained above in relation to FIGS. 5A and 5B, it is not required that the regions 114 are formed from the same material as the elastic seal 100. The regions 114 could be formed from a different material which has a greater rigidity than the remainder of the elastic seal 100. The different material may be nitinol.

As the regions 114 extend along the width of the sidewall 112, they slope towards the longitudinal axis of the elastic seal 100. If the first end 104 is stretched, the regions 114 will be bent away from their original inclinations.

It is beneficial if the regions 114 have a tendency to return to their original inclinations when they are bent away from them. This can be achieved by having the regions 114 more rigid, so they are more resistant to bending, towards the second end 108 and less rigid, so less resistant to bending, towards the first end 104. In other words, the regions 114 may be arranged such that their rigidity varies along the width of the sidewall 112 such that the regions 114 are more rigid towards the second end 108 and less rigid towards the first end 104.

If the regions 114 are made of the same material as the sidewalls 112, the gradient in rigidity can be achieved by a corresponding gradient in thickness of the regions 114. The regions 114 can be thicker and thus more rigid towards the second end 108 and thinner, and thus less rigid, towards the first end 104. As the second end 108 of the elastic seal 100 is longer than the first end 104, there is more room to accommodate the thicker regions 114 towards the second end 108.

If the regions 114 are made of a different, more rigid, material to the sidewall 112 such as nitinol, the regions 114 can be of a uniform thickness. The regions 114 can be fixed to a base embedded with the outer surface 118 of the sidewall 112 and they will naturally try to bounce back to their original angles of inclination if they are bent away from the longitudinal axis of the elastic seal 100.

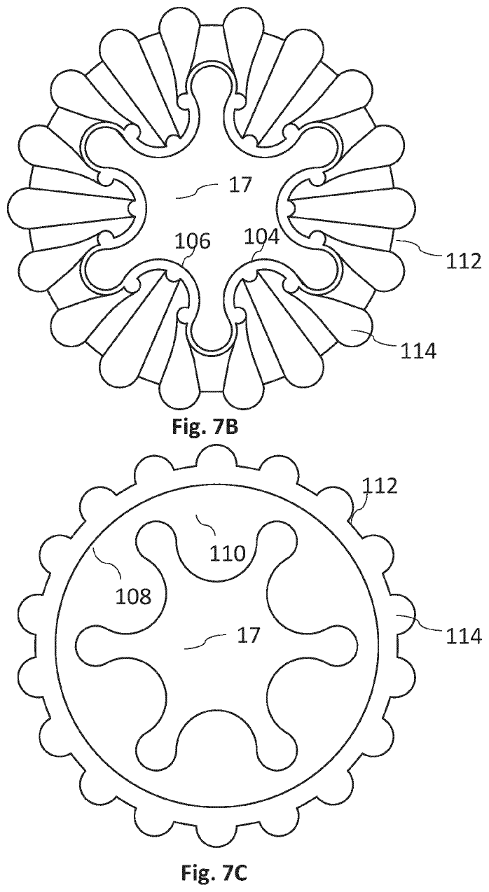

FIGS. 7A to 7C show the elastic seal 100 of FIGS. 6A to 6D applied to a tubular object 17 with a non-convex cross-section. When unstretched, the first end 104 of the elastic seal 100 has a smaller perimeter than the non-convex cross-section and the second end 108 of the elastic seal 100 has a larger perimeter than the non-convex cross-section.

The first end 104 is stretched to enlarge the first opening 106 to accommodate the tubular object 17. The second end 108 and thus the second opening 110 are larger than the tubular object 17 and thus is unstretched.

The regions 114 towards the first end 104 are bent outwardly away from the longitudinal axis of the elastic seal 100. This causes the regions 114 to attempt to spring back towards the longitudinal axis of the elastic seal 100. This causes the regions 114 to urge the inner surface 120 of the sidewall 112 against the tubular object 17 such that the elastic seal 100 presses against both the concavities and the convexities of the non-convex cross-section. The areas of sidewall 112 between the regions 114 are more deformable and thus will be stretched and press against the tubular object 17 under tension. The combination of the regions 114, and the elastic seal 100 having a first end 104 smaller than the second end 108 results in an effective seal formed between the elastic seal 100 and the non-convex tubular object 17.

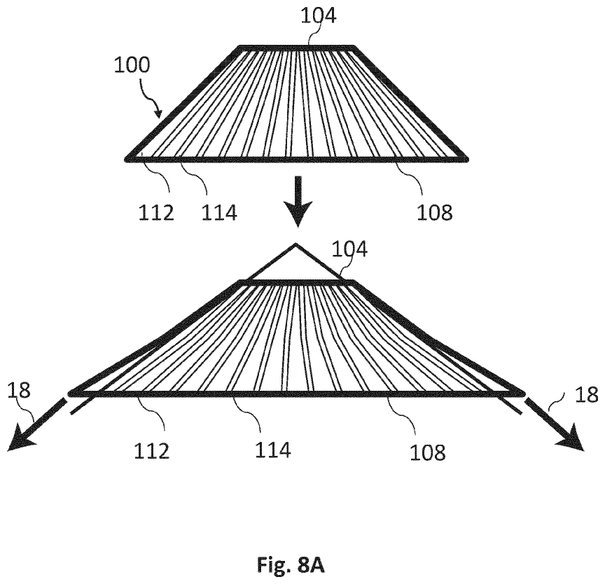

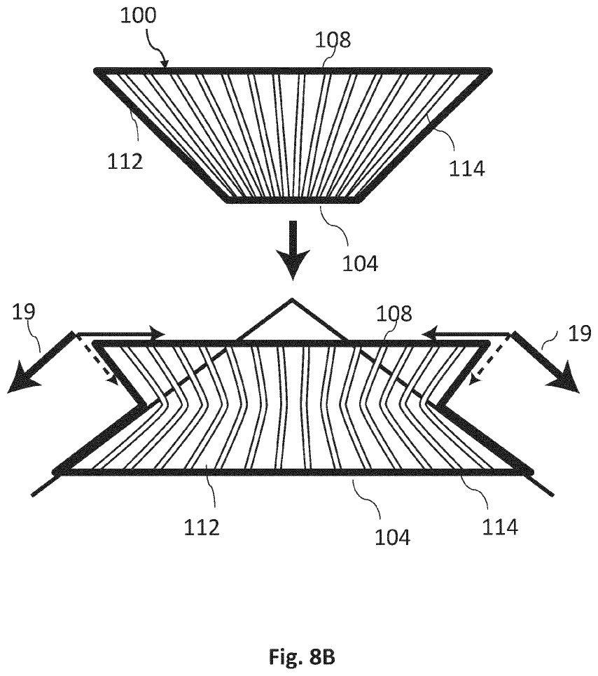

FIGS. 8A and 8B show the elastic seal 100 of FIGS. 6A to 6D applied in two different orientations with respect to a tubular object having a sloped surface.

FIG. 8A shows that the elastic seal 100 is applied second end 108 first over the tubular object. This means that the largest end of the elastic seal 100 receives the object first. The second end 108 can be considered as facing towards the object. The first end 104 can be considered as facing away from the object.

The elastic seal 100 is coupled to the object by a harness (not shown). The harness is coupled to the second end 108 of the elastic seal 100 and applies a securing force to the second end 108 as indicated by the arrows 18. This means that the securing force is applied to the end of the elastic seal 100 that faces towards the object. This forms a stretching securement as described above.

FIG. 8B shows that the elastic seal 100 is applied first end 104 first over the tubular object. This means that the smallest end of the elastic seal 100 receives the object first. The first end 104 can be considered as facing towards the object. The second end 108 can be considered as facing away from the object.

The elastic seal 100 is coupled to the object by a harness (not shown). The harness is coupled to the second end 108 of the elastic seal 100 and applies a securing force to the second end 108 as indicated by the arrows 19. This means that the securing force is applied to the end of the elastic seal 100 that faces away the object. This forms a compressive securement as described above.

Seal effectiveness favours compressive securement as explained above in relation to FIG. 4. Therefore, positioning the first end 104 (smallest end) over the object first generally provides the more effective seal when the harness applies the securing force to the second end 108 (largest end). Moreover, this orientation of seal means that only one cross-section of the tubular object needs to be contained within the projections of the first end 104 and the second end 108 of the elastic seal 100 for the seal to be effective. Other cross-sections of the tubular object can be smaller than the projection of the first end 104 or larger than the projection of the second end 108 of the elastic seal 100.

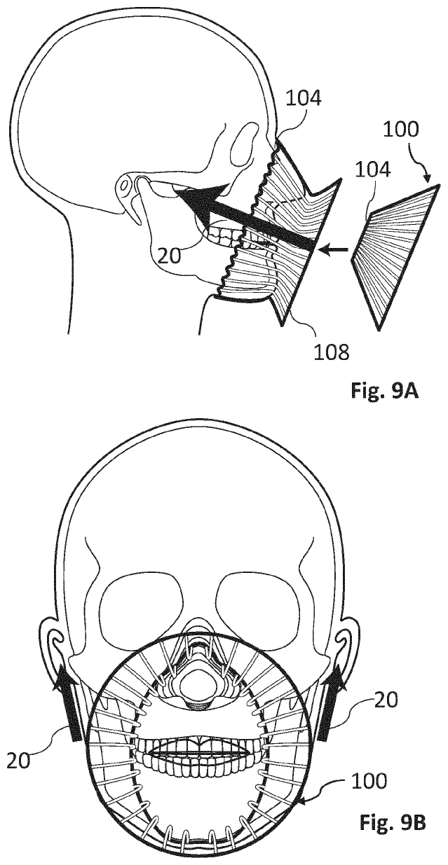

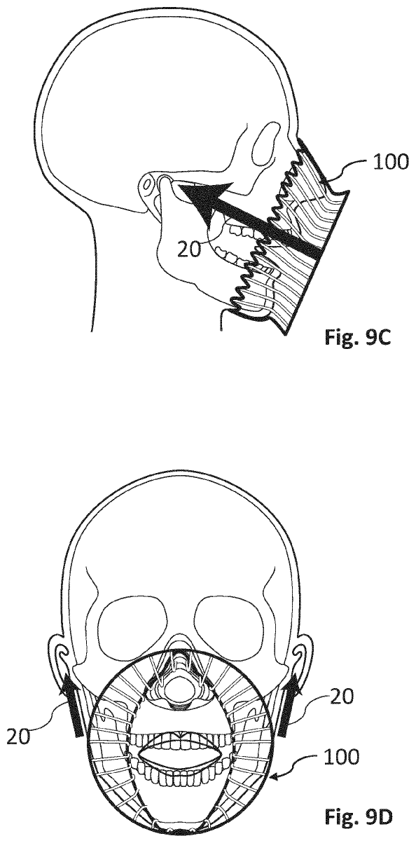

FIGS. 9A to 9D show the elastic seal 100 of FIGS. 6A to 6D being used as a face mask seal for forming a sealing perimeter around the nose and mouth of the wearer. The first end 104 of the seal 100 is stretched over the face of the wearer such that the nose and mouth of the wearer are received within the first end 104. This means that the wearer inhales and exhales through the internal passageway of the seal 100. The inner surface of the seal urges against the wearer to form a tight seal that restricts gas from escaping from the interface between the wearer and the seal 100.

The first end 104 faces towards the wearer and the second end 108 faces away from the wearer.

A harness (not shown) applies a securing force to the second end 108 of the seal 100 that faces away from the wearer as indicated by the arrows 20. This forms a compressive securement.

The regions 114 towards the first end 104 are bent outwardly away from the longitudinal axis of the elastic seal 100. This causes the regions 144 to attempt to spring back towards their original orientation when the elastic seal 100 was unstretched. The regions 114 therefore urge the inner surface of the sidewall 112 against the wearer. The areas of sidewall 112 between the regions 114 are more deformable and thus will be stretched and press against the wearer under tension. This helps form an effective sealing perimeter towards the inner edge (first end 104) of the seal 100.

As the wearer opens their mouth as shown in FIGS. 9C and 9D, the elastic seal 100 is able to adapt its shape to accommodate the change in facial structure. The elastic seal 100 is able to lengthen vertically so that the chin of the wearer remains within the sealing perimeter. Moreover, the regions 114 resist the first end 104 from contracting towards the second end 108 which prevents the sealing perimeter from moving forwards and away from contact with the cheeks. This means that gaps are not formed between the seal 100 and the cheeks of the wearer.

Because of the shape adaptability of the elastic seal 100, a single model can fit snugly with air tightness around the nose and mouth for most wearers. The elastic seal 100 is elastic and intrinsically gentle on the wearer's skin.

Further aspects of the present disclosure relate to a face mask body that can be used with the elastic seals described above or can be used separately to the elastic seals.

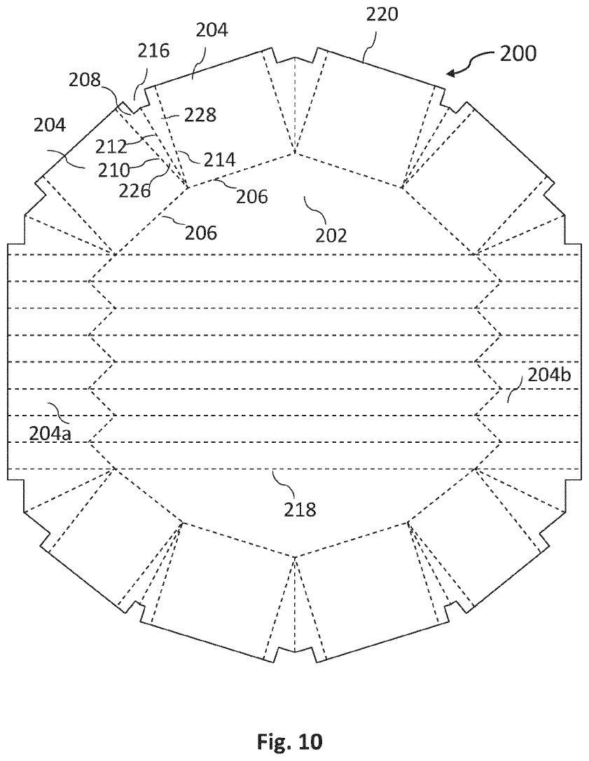

FIG. 10 shows the face mask body 200 in an unassembled configuration. The face mask body 200 comprises a single sheet of flexible but non-extendable porous material. The material is suitable for use as a mask filter.

The mask body 200 comprises a number of stiffened regions that form fold lines. The stiffened regions are stiffer relative to the remainder of the sheet of material. The face mask body 200 is designed to be folded along these fold lines. The fold lines are represented as dashed lines in FIG. 10.

The fold lines divide the face mask body 200 into several regions. The regions comprise a top panel 202 and a plurality of side panels 204. The top panel 202 and the side panels 204 are separated by fold lines 206. The outer most edges 220 of the side panels 204 define a lower margin of the face mask body 200 when assembled.

Valves 208 are provided between the side panels 204. The valves 208 are formed as a result of folding the mask body 200 along three fold lines 210, 212, 214. The central fold line 212 for each valve 208 defines an outer edge of the valve 208. Folding the material along the fold lines 210, 212, 214 forms a pair of sides 226, 228 of the valve 208 that face one another. The outer most edges of the valves 208 (when the mask body 200 is unfolded) include cut-out regions 216 that form tabs when the mask body 200 is assembled.

The stiffened regions also comprise a series of parallel lines 218 that extend horizontally in FIG. 10 across the surface of the top panel 202 and two of the side panels 204a, 204b. The two side panels 204a, 204b are arranged opposite one another and separated by the top panel 202. The mask body 200 is folded along the fold lines 218 to form a series of pleats in the top panel 202 and side panels 204a, 204b.

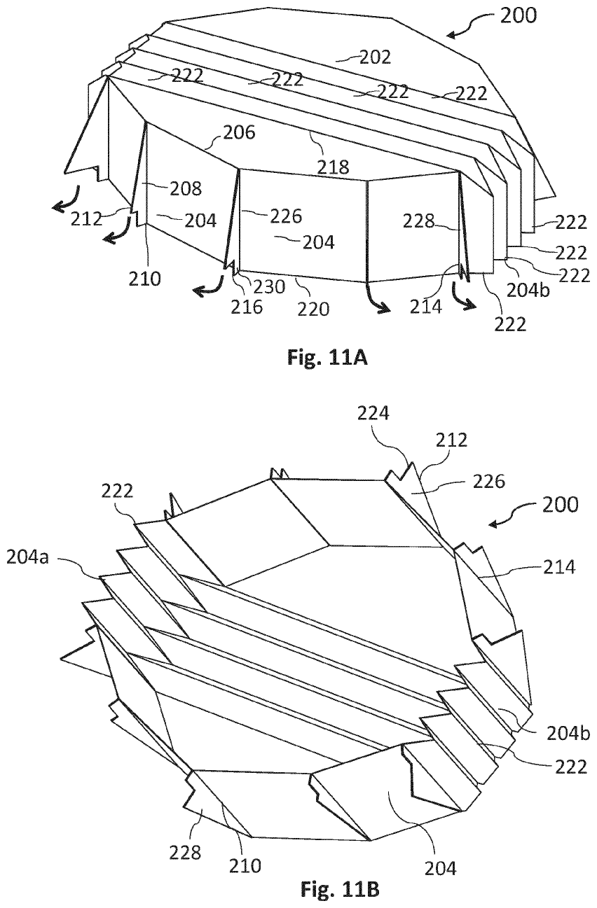

FIGS. 11A and 11B show the mask body 200 as assembled by folding the mask body 200 along the fold lines. The mask body 200 forms a three-dimensional shell having the top panel 202, side panels 204 and an open bottom. The side panels 204 extend vertically downwards from the top panel 202.

The valves 208 project outwardly from the side panels 204. The central fold lines 212 of the valves 208 define the outer edges of the valves 208. The sides 226, 228 of the valves 208 face one another. The sides 226, 228 each have a triangular shape with partial cut-out regions that form the tabs 230, which are rectangular in this example, towards the lower margin 220 of the side panels 204. The sides 226, 228 taper towards the upper margin 206 of the side panels 204. Each valve 208 is bounded by two side panels 204.

The valves 208 each define an air passageway 224 through the tabs 210 that allow for air to enter or exit the mask body 200. The air passageways 224 are normally closed as the sides 226, 228 push against one another. However, when the air pressure within the mask body 200 increases the sides 226, 228 move away from one another to form the air passageway 224.

In addition to be used to selectively allow gas to escape from the mask body 200, one or more of the valves 208 can receive a conduit for delivering or removing gas from the mask body 200. Conduits may be used during externally assisted ventilation.

The parallel fold lines 218 form a series of pleats 222 in the top panel 202 and the side panels 204a, 204b. The pleats 222 formed in the side panels 204a, 204b are each aligned with a corresponding pleat 222 formed in the top panel 202. In this example, the top panel 202 defines four pleats 222, and each of the side panels 204a, 204b defines a corresponding four pleats 222.

The pleats 222 provide a semi-rigid frame that allows the assembled mask body 200 shell to expand and collapse in a direction orthogonal to the parallel fold lines 218 without tearing the filter material that forms the mask body 200. The pleats 222 may be referred to as concertina or bellow folds and are similar to the folding arrangements used to make bellows and accordions.

The pleats 222 increase the surface area of the mask body 200 available for filtering and therefore reduce the airflow resistance. This makes breathing easier for the wearer and is more energy efficient.

The pleats 222 provide structure for the mask body 200 and help ensure that the mask body 200 does not collapse around the wearer's nose and mouth during inhalation. Despite providing structure, the pleats 222 do not add additional bulk and weight to the mask body 200 in contrast to rigid frames used with existing mask bodies.

The pleats 222 also enable the mask to increase its vertical dimension (direction perpendicular to the pleats 222) while maintaining its horizontal dimension (direction parallel to the pleats 222) when the wearer opens their mouth

The pleats 222 also function as bellows when actuated by the jaw muscles of the wearer to refresh the air in the mask body 200, aid the wearer's breathing, or force out water vapour that may otherwise condense into droplets within the mask body 200. This bellow function can be intentionally activated by the wearer or may occur coincidentally such as when the wearer speaks.

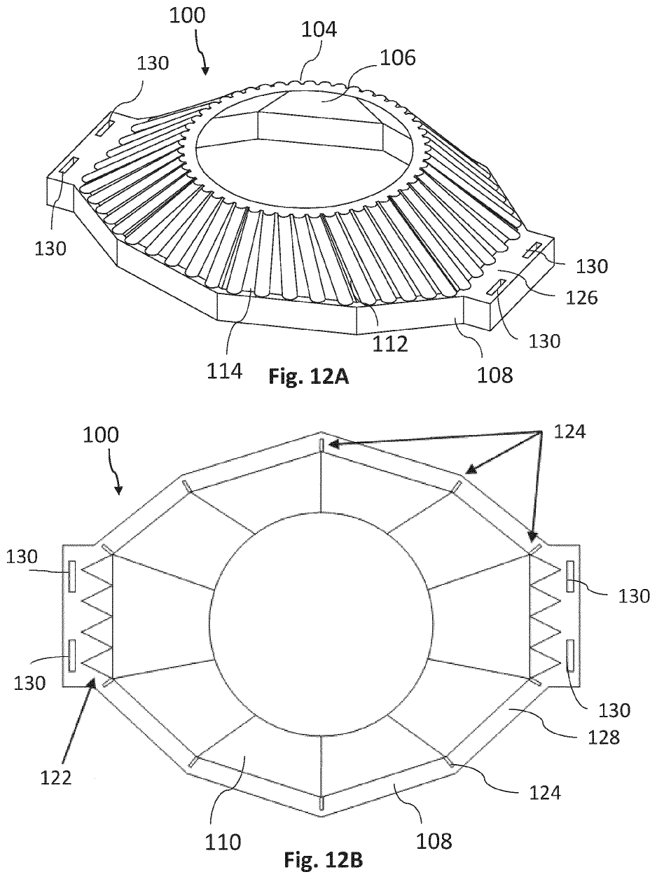

FIGS. 12A and 12B show an elastic seal 100 arranged to support the mask body 200 of FIGS. 11A to 11B. The elastic seal 100 is similar to the elastic seal 100 of FIGS. 6A to 6D and like reference numerals are used to indicate like components.

The second end 108 of the elastic seal 100 is arranged to receive the mask body. When mounted on the elastic seal 100, the mask body is arranged to cover the second opening 110 defined by the second end 108.

The second end 108 has a first surface 126 that faces towards the first end 104 and a second surface 128 that faces away from the first end 104.

The second surface 128 of the second end 108 is arranged to accommodate the pleats 222 formed in the side panels 204a, 204b. A series of recesses 122 are formed in the second surface 128. The recesses have a corresponding size and shape to the pleats 222 and in this example are in the form of triangular-shaped slots.

The second surface 128 of the second end 108 is also arranged to accommodate the tabs 230 of the valves 208. A series of recesses 124 are formed in the second surface 128. The recesses have a corresponding size and shape to the tabs 230 and in this example are in the form of slits 124.

The second end 108 of the elastic seal 100 also comprises mounting points 130 for a harness.

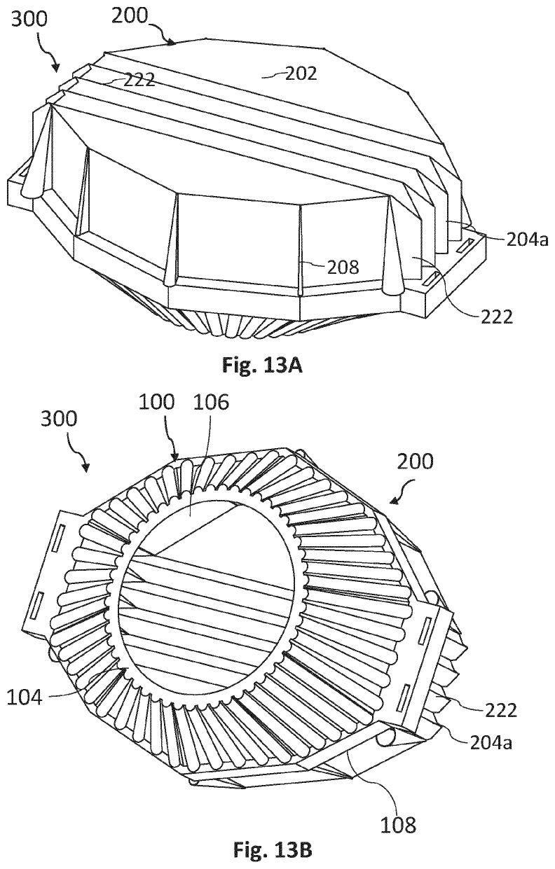

FIGS. 13A and 13B show the mask body 200 mounted on the elastic seal 100. This forms a face mask 300. The pleats 222 formed in the side panels 204a, 204b are received in the recesses 122 (FIG. 12B). The tabs 230 of the valves 208 are received in the recesses 124 (FIG. 12B). The sides 226, 228 (FIGS. 11A and 11B) of the valves 208 project outwardly and overhang the second end 108. This means that when the sides 226, 228 move away from one another to open the valve 208, the air passageway 224 is not covered by the second end 108. This allows air to be vented outside when the internal pressure within the mask body 200 rises above the external pressure. When the internal pressure is equal or below the external pressure, the sides 226, 228 collapse towards one another under negative pressure and the air passageways 224 are closed. The valves 208 are therefore non-return valves and can be considered as forming duckbill-type valves.

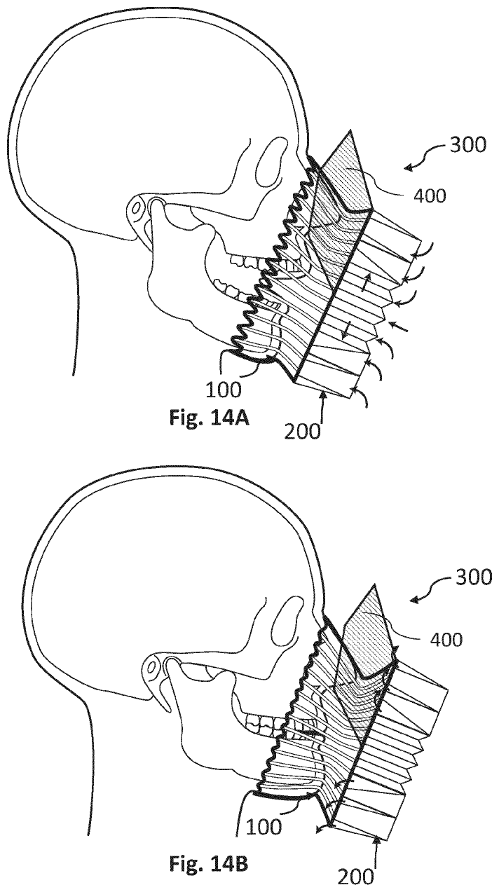

FIGS. 14A and 14B show the face mask 300 as worn. FIG. 14A shows the wearer opening their mouth. This increases the length of the mask body 200 in the vertical direction (assuming the wearer is upright). The pleats 222 (FIG. 11A) enable the mask body 200 to also extend in the vertical dimension while maintaining their shape in the horizontal dimension. This causes an increase in the volume within the face mask 300 which decreases the internal pressure. This causes air to be sucked into the mask through the porous material of the mask body 200 to equalise the pressure. This mechanism for air exchange makes it easer for the wearer to inhale while wearing the face mask 300. The wearer may not have to inhale as strongly to suck air through the material.

FIG. 14B shows the wearer closing their mouth. The mask body 200 returns to its original dimensions under recoil of the elastic seal 100. The pressure within the face mask 300 rises above the external pressure and the valves 208 open up. This causes air to flow out of the face mask 200 via the air passageways 224 formed in the valves 208 (FIGS. 11A and 11B).

The wearer opening and closing their mouth therefore causes the pleats 222 to perform a bellows function to effectively pump air into and out of the mask body 200.

When the wearer exhales, the pressure within face mask 300 rises and the valves 208 open. The valves 208 point backwards from the wearer's nostril and mouth, which means that air currents first hit the top panel 202 of the mask body 200 before bouncing off into the valves 208 for expulsion. Water and mucus droplets and other large particles expelled by the wearer are likely to be deposited on the top panel 202 and only air and gases are expelled to the outside through the backward-facing valves 208.

A piece of clear plastic or other transparent material can easily be mounted or integrated onto the mask body 200 to form a visor 400.

The mask body 200 is formed from a porous material that is suitable to act as a filter. A separate filter is not required as the mask body itself forms the filter. The filter is arranged to trap elements such as microbes and particulates such as dusts and pollens while allowing air exchange with the external environment. Any porous material such as a porous fabric can be used to make the mask body. For some advantageous arrangements, the mask body comprises polytetrafluoroethylene (PTFE) and in particular expanded or sintered PTFE or a structurally reinforced composite material based on porous PTFE. Using PTFE or a composite therefore allows the mask body 200 to be cleaned at a molecular level through capillary action with perfluorocarbons. This allows the mask body 200 to be reconditioned and reused. In one example, the mask body 200 is formed from a porous PTFE material that is sandwiched between two protective mesh layers.

Due to the advantageous construction of the mask body 200, the porous material may have a pore size of less than or equal to 1.0 μm, less than or equal to 0.7 μm, or less than or equal to 0.5 μm. A small pore size such as a pore size of less than or equal to 0.5 μm is particularly effective at blocking bacteria and viruses as well as other particles. The mask body 200 construction enables acceptable airflow resistance for the wearer even at these small pore sizes.

In summary, there is provided a face mask, seal and mask body. The seal is an elastic seal and forms a sealing perimeter around the nose and mouth of a wearer. The elastic seal 100 comprises a first end 104 defining a first opening, a second end 108 defining a second opening in communication with the first opening, and a sidewall 112 extending between the first end 104 and the second end 108. The mask body 200 comprises a porous material. The mask body 200 is supported on the elastic seal 100 such that it covers the second opening of the elastic seal 100. The elastic seal 100 may comprise regions 114 distributed around a perimeter of the sidewall 112 and having a greater rigidity than a remainder of the elastic seal 100. The mask body may comprise a top panel 202 with one or more pleats 222.

Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one. or any novel combination, of the features disclosed in this specification (including any accompanying claims, abstract and drawings), or to any novel one, or any novel combination, of the steps of any method or process so disclosed.

1. A face mask comprising:
an elastic seal arranged to form a sealing perimeter around the face of a wearer, the elastic seal comprising:
a first end defining a first opening;
a second end defining a second opening in communication with the first opening; and
a sidewall extending between the first end and the second end;
a mask body comprising a porous material, wherein the mask body is supported on the elastic seal such that it covers the second opening of the elastic seal.

2. A face mask as claimed in claim 1, wherein the elastic seal comprises a plurality of regions distributed around a perimeter of the sidewall, the plurality of regions having a greater rigidity than a remainder of the elastic seal.

3. A face mask as claimed in claim 2, wherein at least one of the plurality of regions extends along the sidewall from the first end to the second end.

4. A face mask as claimed in claim 2 or 3, wherein the rigidity of at least one of the plurality of regions varies such that the at least one of the plurality of regions is more rigid towards the second end and less rigid towards the first end.

5. A face mask as claimed in any of claims 2 to 4, wherein the regions are formed from the same material as the sidewall.

6. A face mask as claimed in claim 5 wherein the regions have a greater rigidity than the sidewall as a result of being thicker than the sidewall.

7. A face mask as claimed in claim 6, wherein the regions are integrally formed with the sidewall.

8. A face mask as claimed in claim 6 or 7, wherein the regions project from an outer surface of the sidewall to form a plurality of ridges.

9. A face mask as claimed in claim 8, wherein the regions are formed from a different material to the sidewall.

10. A face mask as claimed in claim 9 wherein the regions comprise a material having shape-memory such as nitinol.

11. A face mask as claimed in any one of claims 2 to 10, wherein the regions comprise more material towards the second end and less material to towards the first end.

12. A face mask as claimed in any preceding claim, wherein, when unstretched, the first end of the elastic seal is smaller than the second end.

13. A face mask as claimed in claim 12, wherein the elastic seal forms a substantially frustoconical shape when unstretched.

14. A face mask as claimed in claim 12 or claim 13, wherein the plurality of regions converge towards the first end and spread apart towards the second end.

15. A face mask as claimed in any preceding claim, wherein the mask body comprises a flexible and non-extendable porous material that is folded to form a three-dimensional shell comprising a top panel and a plurality of side panels extending from the top panel.

16. A face mask as claimed in claim 15, wherein the top panel comprises at least one pleat, and optionally a plurality of pleats.

17. A face mask as claimed in claim 16, wherein two of the side panels arranged opposite one another and separated by the top panel comprise a corresponding at least one pleat.

18. A face mask as claimed in any of claims 15 to 17, wherein the mask body further comprises a valve provided between a pair of adjacent side panels, wherein the valve is arranged to open in response to the pressure within the mask body increasing.

19. A face mask as claimed in claim 18, wherein the valve is formed as a result of folding the mask body along three fold lines.

20. A face mask as claimed in any preceding claim, further comprising a harness arranged to support the elastic seal on the object, and optionally wherein the harness is coupled to the second end of the elastic seal.

21. A face mask as claimed in any preceding claim, wherein the elastic seal comprises at least one recess sized to accommodate part of the mask body.

22. A face mask as claimed in claim 21 wherein the at least one recess is formed in a surface of the second end that faces away from the first end.
